(19) United States
(12) Patent Application Publication
(10) Pub. No.: US 2024/0411981 A1
(43) Pub. Date: Dec. 12, 2024

(54) VALUE-BASED LARGE LANGUAGE MODEL TEAMING

(71) Applicant: Pharma Solutions USA, Inc., Penn Valley, PA (US)

(72) Inventor: Rick BRADDY, Cypress, TX (US)

(73) Assignee: Pharma Solutions USA, Inc., Penn Valley, PA (US)

(21) Appl. No.: 18/734,027

(22) Filed: Jun. 5, 2024

Related U.S. Application Data
(60) Provisional application No. 63/507,121, filed on Jun. 9, 2023.

(51) Int. Cl. G06F 40/166; G06F 8/30; G06F 40/253

(52) U.S. Cl. CPC G06F 40/166; G06F 8/30; G06F 40/253

(57) ABSTRACT

Systems and techniques for content editing are described. In some examples, a content processing system receives content, for instance from a user interface, a creator large language model (LLM), or an editor LLM. The content processing system provides a prompt to a critic LLM that is configured to use the prompt to critique the content according to rule(s) to generate critique(s) of the content. The prompt includes the content and identifies rule(s) that the critic LLM is to critique the content according to. The content processing system receives the critique(s) of the content from the critic LLM. The content processing system provides a second prompt to an editor LLM that is configured to use the second prompt to edit the content according to the critique(s) to generate edited content. The second prompt includes the content and the critique(s). The content processing system receives the edited content from the editor LLM.

### CROSS-REFERENCE TO RELATED APPLICATIONS

This application claims priority to U.S. Provisional Application No. 63/507,121, filed Jun. 9, 2023, which is hereby incorporated by reference, in its entirety and for all purposes.

### BACKGROUND

### 1. Field

The present technologies are generally related to use of trained machine learning models for content creation, critiquing, and/or editing. More specifically, the present teachings relate to use of large learning models (LLMs) for content creation, critiquing, and/or editing.

### 2. Description of the Related Art

A large language model (LLM) is a language model including at least one machine learning (ML) model that is trained, using training data, to generate content.

### SUMMARY

Systems and techniques for content creation, critiquing, editing, and/or processing are described. In some examples, a content processing system receives content, for instance from a user interface a creator large language model (LLM), or an editor LLM. The content processing system provides a prompt to a critic LLM that is configured to use the prompt to critique the content according to at least one rule to generate at least one critique of the content. The prompt includes the content and identifies the at least one rule that the critic LLM is to critique the content according to. The content processing system receives the at least one critique of the content from the critic LLM. The content processing system provides a second prompt to an editor LLM that is configured to use the second prompt to edit the content according to the at least one critique of the content to generate edited content, the second prompt including the content and the at least one critique of the content. The content processing system receives the edited content from the editor LLM. In some examples, the content processing system runs one or more additional cycles of critiquing and editing using the edited content in place of the content, for instance until the edited content meets or exceeds a predetermined quality condition, or the number of total cycles meets or exceeds a maximum threshold number of cycles. In some examples, two or more of the above-discussed LLMs (e.g., the creator LLM, the critic LLM, or the editor LLM) can actually be a single LLM rather than distinct LLMs.

In one example, an apparatus for content editing is provided. The apparatus includes at least one memory; and at least one processor coupled to the at least one memory and configured to: receive content; provide a prompt to a critic large language model (LLM) that is configured to use the prompt to critique the content according to at least one rule to generate at least one critique of the content, the prompt including the content and identifying the at least one rule that the critic LLM is to critique the content according to; receive the at least one critique of the content from the critic LLM; provide a second prompt to an editor LLM that is configured to use the second prompt to edit the content according to the at least one critique of the content to generate edited content, the second prompt including the content and the at least one critique of the content; and receive the edited content from the editor LLM.

In another example, a method for content editing is provided. The method includes receiving content; providing a prompt to a critic large language model (LLM) that is configured to use the prompt to critique the content according to at least one rule to generate at least one critique of the content, the prompt including the content and identifying the at least one rule that the critic LLM is to critique the content according to; receiving the at least one critique of the content from the critic LLM; providing a second prompt to an editor LLM that is configured to use the second prompt to edit the content according to the at least one critique of the content to generate edited content, the second prompt including the content and the at least one critique of the content; and receiving the edited content from the editor LLM.

In another example, a non-transitory computer-readable medium is provided having stored thereon instructions that, when executed by one or more processors, cause the one or more processors to: receive content; provide a prompt to a critic large language model (LLM) that is configured to use the prompt to critique the content according to at least one rule to generate at least one critique of the content, the prompt including the content and identifying the at least one rule that the critic LLM is to critique the content according to; receive the at least one critique of the content from the critic LLM; provide a second prompt to an editor LLM that is configured to use the second prompt to edit the content according to the at least one critique of the content to generate edited content, the second prompt including the content and the at least one critique of the content; and receive the edited content from the editor LLM.

In another example, an apparatus for content editing is provided. The apparatus includes means for receiving content; means for providing a prompt to a critic large language model (LLM) that is configured to use the prompt to critique the content according to at least one rule to generate at least one critique of the content, the prompt including the content and identifying the at least one rule that the critic LLM is to critique the content according to; means for receiving the at least one critique of the content from the critic LLM; means for providing a second prompt to an editor LLM that is configured to use the second prompt to edit the content according to the at least one critique of the content to generate edited content, the second prompt including the content and the at least one critique of the content; and means for receiving the edited content from the editor LLM.

The foregoing, together with other features and aspects, will become more apparent upon referring to the following specification, claims, and accompanying drawings.

### BRIEF DESCRIPTION OF THE FIGURES

FIG. 1 is a block diagram illustrating an architecture of a content processing system, in accordance with some examples;

FIG. 2 is a block diagram illustrating an architecture of a content processing system with a manager agent, a creation agent, a critique agent, a value agent, and a results agent, in accordance with some examples;

FIG. 3 is a block diagram illustrating an architecture of a content processing system for developing software code for a program, in accordance with some examples;

FIG. 4 is a block diagram illustrating training of, use of, and/or updating of one or more large language models in the context of a content processing system, in accordance with some examples;

FIG. 5 is a block diagram illustrating a retrieval augmented generation (RAG) system that may be used to implement some aspects of the technology, in accordance with some examples;

FIG. 6 is a flow diagram illustrating exemplary operations for a process for content editing, in accordance with some examples; and

FIG. 7 is a block diagram of an exemplary computing device that may be used to implement some aspects of the technology.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

A large language model (LLM) is a language model including at least one machine learning (ML) model that is trained, using training content, to generate content. A content processing system can use an LLM for various tasks, such as predicting next word(s) in a text string based on existing words in the text string (e.g., given to the LLM as a prompt), summarizing content (e.g., the content given to the LLM as a prompt) to generate a summary of the content, analyzing content (e.g., the content given to the LLM as a prompt) to generate an analysis of the content, translating content (e.g., the content given to the LLM as a prompt) from one language to another, generating content requested in a prompt, or a combination thereof. In some cases, LLMs can suffer from a number of technical problems, such as errors (e.g., mistakes and/or omissions), hallucinations (e.g., false responses), misinterpretations of prompts, forgetting aspects of a request in a prompt, and varied level(s) of quality. In some cases, human reviewers can review and edit the output of an LLM to correct errors or mistakes in the output, add in missing information to overcome omissions in the output, correct or remove hallucinations in the output, revise the output to account for the LLM misinterpreting or forgetting part of the prompt, and/or revise the output to improve quality.

However, having human reviewer(s) correct issues with the output(s) of an LLM can be time and resource intensive, in some cases involving human beings rewriting significant portions of the output generated by the LLM. This can limit the usefulness of the LLM, and can make the human reviewer(s) into a bottleneck for generating content. In some cases, LLMs can take several minutes to generate an output. Relying on human reviewers on top of this can result in a stop-and-go process that can ultimately take a long period of time before the output of the LLM reaches or exceeds a desired level of quality. The need for human reviewers can be mitigated in a content processing system by using a critic LLM to review content to generate critique(s) of the content based on rule(s) and an editor LLM to edit the content based on the critique(s) of the content.

Systems and techniques for content creation, critiquing, editing, and/or processing are described. In some examples, a content processing system receives content, for instance from a user interface a creator large language model (LLM), or an editor LLM. The content processing system provides a prompt to a critic LLM that is configured to use the prompt to critique the content according to at least one rule to generate at least one critique of the content. The prompt includes the content and identifies the at least one rule that the critic LLM is to critique the content according to. The content processing system receives the at least one critique of the content from the critic LLM. The content processing system provides a second prompt to an editor LLM that is configured to use the second prompt to edit the content according to the at least one critique of the content to generate edited content, the second prompt including the content and the at least one critique of the content. The content processing system receives the edited content from the editor LLM. In some examples, the content processing system runs one or more additional cycles of critiquing and editing using the edited content in place of the content, for instance until the edited content meets or exceeds a predetermined quality condition, or the number of total cycles meets or exceeds a maximum threshold number of cycles. In some examples, two or more of the above-discussed LLMs (e.g., the creator LLM, the critic LLM, or the editor LLM) can actually be a single LLM rather than distinct LLMs.

By using a critic LLM to critique content and an editor LLM to edit the content based on the critiques, the content processing system can generate high quality content without human interaction. For instance, using such a content processing system, by the time content is output, the content will have already been critiqued by the critic LLM and edited by the editor LLM at least once, generally fixing at least the most prominent or severe issues. Using different LLMs for creation, critiquing, and/or editing can also allow each LLM to mitigate hallucinations from the other LLM(s) without human interaction. Splitting up tasks (between creation, critiquing, and/or editing) can also help to overcome size limitations on prompts, outputs, and/or other interactions with LLMs. The different LLMs (e.g., creation LLM, critic LLM, and/or editor LLM) can each be given access to various data sources to draw information from, such as data structures (e.g., databases) and/or various online sources on the Internet, either as training data or to more directly pull information from those data sources to use in outputs. By giving each LLM access to these data sources, the LLMs can cross-check information in the content and correct one another.

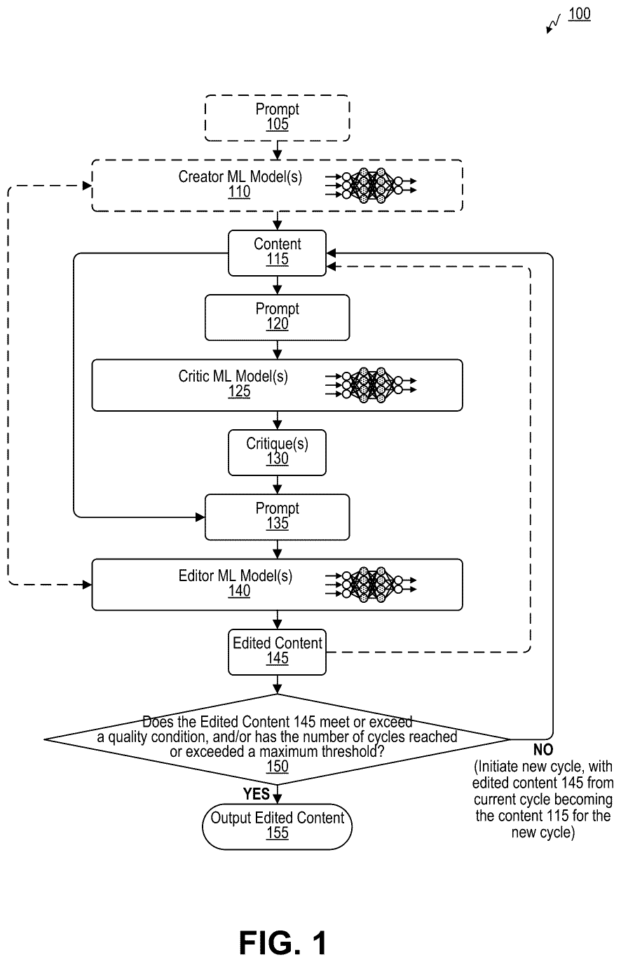

FIG. 1 is a block diagram illustrating an architecture of a content processing system 100. The content processing system 100 includes one or more trained machine learning (ML) models. The trained machine learning (ML) model(s) of the content processing system 100 can include, for instance creator ML model(s) 110, critic ML model(s) 125, editor ML model(s) 140, or a combination thereof. In some examples, the content processing system 100 includes creator ML model(s) 110 that are configured to generate content 115 based on a prompt 105 that is input to the creator ML model(s) 110.

The content processing system 100 generates a prompt 120 for the critic ML module(s) 125 based on the content 115. In some examples, the prompt 120 includes the content 115 or otherwise references the content 115 (e.g., includes a link, a pointer, or another resource identifier referring to the content 115 or a device or network location at which the content 115 is stored). The prompt 120 can also identify at least one rule that the critic ML model(s) 125. Based on the prompt 120, the critic ML model(s) 125 are requested to critique the content 115 according to the at least one rule to generate one or more critiques 130 of the content 115. In response to input of the prompt 120 to the critic ML model(s) 125, the critic ML model(s) 125 are configured to, and can, critique the content 115 according to the at least one rule to generate the critique(s) 130 of the content 115. The content processing system 100 receives the critique(s) 130 of the content 115 from the critic ML module(s) 125.

The content processing system 100 generates a prompt 135 for the editor ML module(s) 140 based on the content 115 and the critique(s) 130 of the content 115. In some examples, the prompt 135 includes both the content 115 and the critique(s) 130 of the content 115, with instructions for the editor ML module(s) 140 to edit or revise the content 115 to correct issue(s) with the content 115 based on the critique(s) 130 to generate edited content 145 in which the issue(s) are corrected or resolved. In response to input of the prompt 135 to the editor ML module(s) 140, the editor ML module(s) 140 are configured to, and can, edit the content 115 according to the critique(s) 130 to generate the edited content 145 in which issues indicated in the critique(s) 130 are corrected or resolved. The content processing system 100 receives the edited content 145 from the editor ML module(s) 140.

At an operation 150, the content processing system 100 can either proceed to operation 155 to output the edited content 145, or can treat the edited content 145 as if it was the content 115 to perform another cycle of critiquing (using the critic ML model(s) 125) and editing (using the editor ML model(s) 140). In some cases, at operation 150, the content processing system 100 can proceed to operation 155 to output the edited content 145 if the total number of cycles (of critiquing and editing) has reached or exceeded a predetermined maximum threshold number of cycles (e.g., 1, 2, 3, 4, 5, 6, 7, 8, 9, 10, or more than 10 cycles).

In some cases, at operation 150, the content processing system 100 can proceed to operation 155 to output the edited content 145 if the edited content 145 meets or exceeds a quality condition, and can otherwise perform another cycle. In some examples, at operation 150, the content processing system 100 can analyze the edited content 145 (e.g., using the critique ML model(s) 125) to determine whether the quality condition has been met.

In some cases, for example, the critic ML model(s) 125 can grade, score, or rate the content along a scale, with different values along the scale indicating, for instance, type of issue, severity of issue, and the like. Issues can include, for instance, various errors, mistakes, omissions, hallucinations, grammatical issues, or other issues. In situations where the content 115 that is being created, critiqued, and/or edited includes code (e.g., program instructions), the issues found by the critic ML model(s) 125 can include issues with code, such as memory leaks, security issues, performance issues, crashes, and/or other types of bugs. In some cases, issues with different types or severities can correspond to additions to, or deductions from, a score. In some examples, the score can be referred to as a heuristic or a grade. For instance, in some examples, where the content 115 being created, critiqued, and/or edited includes code (e.g., program instructions), the critic ML model(s) 125 can score content according to the following rubric:
P0: Critical, Urgent—“Showstopper, Blocker, Crash, Memory Leak, Security Breach”: Deduct 10 points
P1: High, Urgent—“Major Functionality Bugs, Significant Performance Degradation”: Deduct 7 points
P2: High, Non-Urgent—“Usability Issues, Minor Performance Issues, Moderate Functionality Bugs”: Deduct 5 points
P3: Medium, Urgent—“Minor UI/UX Issues, Spelling Errors, Non-Critical Functionality Bugs”: Deduct 3 points
P4: Medium, Non-Urgent—“Rare Edge Cases, Minor Inconsistencies”: Deduct 2 points
P5: Low, Non-Urgent—“Cosmetic Issues”: Deduct 1 point

According to the rubric (e.g., rules) above, different types of issues can result in different amounts of points being deducted from a score. In some cases, a rubric or rule can also add points, for instance if code compiles and/or executes without causing an error or crashing. In some cases, the critique(s) 130 include the score and/or an indication of the categorization(s) of individual issues. In some examples, the quality condition in operation 150 is based on comparison of the score to a score threshold (e.g., 10). For instance, if the score is at or above a certain quality threshold, then the content processing system 100 can consider the quality condition to be met or exceeded.

In some examples, scoring, heuristics, and/or grading can be more granular than the P0-P5 scoring rubric identified above. For instance, in some examples, the critic ML model(s) 125 can evaluate the content 115 can generate separate scores, heuristics, and/or grades for different categories of quality metrics (and/or different categories of potential issues) such as accuracy, spelling, punctuation, UI/UX issues, cosmetic issues, edge cases, inconsistencies, functionality bugs, performance issues, usability issues, compatibility issues, crashes, memory leaks, security breaches, showstoppers, blockers, missing documents or files, unnecessary documents or files, or combinations thereof. In some examples, these separate scores, heuristics, and/or grades for different categories of quality metrics (and/or different categories of potential issues) can be fed into the ML model(s) 140 as critique(s) 130 (e.g., and/or the critique(s) 415) and/or as part of the prompt 135, and the editor ML model(s) 140 can generate the edited content 145 to improve the content 115 with respect to the different categories of quality metrics (and/or different categories of potential issues) for which the corresponding scores, heuristics, and/or grades indicate presence of issues.

In some examples, the critic ML model(s) 125 can analyze the content 115 to identify whether a document, file, attachment, and/or other piece of content is missing from the content 115. For instance, if the content 115 is an email in which the body of the email refers to an attachment (e.g., “please see the attached file”) but no file is attached, the critique(s) 130 from the critic ML model(s) 125 can identify that the attachment and/or file appears to be missing. The edited content 145 generated by the editor ML model(s) 140 can either locate and attach the attachment and/or file, or can remove the reference to the attachment from the body of the email.

If the content 115 includes code for a piece of software that calls, points to, or otherwise references a function, library, variable, data structure, and/or file that appears to be missing from the content 115, the critique(s) 130 from the critic ML model(s) 125 (e.g., CodeBot 330 and/or DebugBot 340) can identify that at least one piece of content (e.g., with the function, library, variable, data structure, and/or file) is missing. The edited content 145 generated by the editor ML model(s) 140 can either locate and add in the missing piece of content (e.g., with the function, library, variable, data structure, and/or file), or can remove the reference to (e.g., the call or pointer to) the piece of content from the code.

In some examples, the content 115 may include one or more plans or decisions (e.g., as in plan(s) and/or decision(s) generated using the ProjectManagerBot 305, the BudgetBot 310, the ProductOwnerBot 315, the ArchitectBot 320, and/or the DesignBot 325). In some examples, the critic ML model(s) 125 can generate the critique(s) 130 to assess and/or critique the plan(s) and/or decision(s), for instance to assess and/or critique the accuracy and/or viability of the plan(s) and/or decision(s) based on model(s), rule(s), and/or examples of similar plan(s) and/or decision(s) associated with similar industries, companies, types of projects, types of products, types of services, or a combination thereof. In some examples, the critic ML model(s) 125 can generate the critique(s) 130 to assess and/or critique the accuracy and/or viability of the plan(s) and/or decision(s) in light of contextual information, such as a market landscape (e.g., how saturated a market associated with the plan(s) and/or decision(s) is), competitors (e.g., and what the competitors are doing relative to the associated with the plan(s) and/or decision(s)), market conditions (e.g., whether a market associated with the associated with the plan(s) and/or decision(s) is doing well or not), other contextual factors discussed herein, or combinations thereof. For instance, if the critic ML model(s) 125 determines (and indicates in the critique(s) 130) that the plan(s) and/or decision(s) are too similar to something from a competitor, or are in a sector of a market that is oversaturated and/or underperforming, the ML model(s) 140 can modify the content 115 by changing the plan(s) and/or decision(s) in a direction that steers the plan(s) and/or decision(s) away from what the competitor is doing, and/or away from the sector of the market that is oversaturated and/or underperforming.

In some cases, for example, the critic ML model(s) 125 can evaluate the content 115 in the critique based on how closely the content 115 aligns with, meets, matches, or fulfills request(s) in the prompt 105 (and/or in the prompt 135 it the content being critiqued has already been edited by the editor ML model(s) 140 and is going through another cycle of critiques). For instance, the prompt 120 to the critic ML model(s) 125 can include a copy of at least a portion of the prompt 105 (or the prompt 135) and a statement requesting that the critic ML model(s) 125 evaluate the content 115 based on whether the “original content request and its intentions, requirements and details” are met.

In an illustrative example, if the prompt 105 may state:
Generate 3 standard operating procedures (SOP) for DevOps that meets best practices. Be sure to show each SOP title, along with a paragraph between 50 and 100 words.

In an illustrative example, the creator ML model(s) 110 may generate the following content 115:
1. Continuous Integration and Deployment (CI/CD): Establish a robust CI/CD pipeline to ensure the rapid and consistent delivery of software updates. This includes automated testing, code reviews, and deployment to staging and production environments. By streamlining the development process, teams can quickly identify and rectify issues, reducing the risk of production downtime and ensuring a high-quality end product.
2. Infrastructure as Code (IaC): Implement IaC practices to manage and provision infrastructure through code, rather than manual processes. This allows for version control, collaboration, and the ability to roll back changes when necessary. IaC ensures a consistent and repeatable environment, reducing the risk of human error and making it easier to scale and maintain infrastructure.
3. Monitoring and Logging: Establish comprehensive monitoring and logging practices to track application performance and infrastructure health. This includes collecting and analyzing metrics, logs, and alerts to identify potential issues and bottlenecks. By proactively monitoring and addressing issues, DevOps teams can maintain optimal performance and minimize downtime, ensuring a positive user experience.

In the illustrative example, the prompt 120 to the critic ML model(s) 125 may read:
You are to operate as a Expert Reviewer, critic and quality assurance professional. Your job is to find errors, issues and areas for improvement to review, critique and provide objective, critical feedback using the latest content below.
Evaluate the latest content shown below after “Content:”, by determining how well it meets these:
1. Original content request and its intentions, requirements and details must be met: Generate 3 standard operating procedures (SOP) for DevOps that meets best practices. Be sure to show each SOP title, along with a paragraph between 50 and 100 words
2. Goals: —Create quality content, minimize number of retries/corrections required by being thorough in your responses.
3. Values: —Quality: free from errors, omissions, flaws, defects, or other problems
   Beautiful: content should be well-formatted, look good and suitable for the stated goals and values
   Functional: content must meet the functional and other goals and values
   Understandable: content must be properly commented and self-documenting (where applicable, like with coding).
Upon content review completion, list each defect, issue, comment or suggestion for improvement arising from your review, whereby each reported line item shows a rating using this
P0: Critical, Urgent—“Showstopper, Blocker, Crash, Memory Leak, Security Breach”: Deduct 10 points
P1: High, Urgent—“Major Functionality Bugs, Significant Performance Degradation”: Deduct 7 points
P2: High, Non-Urgent—“Usability Issues, Minor Performance Issues, Moderate Functionality Bugs”: Deduct 5 points
P3: Medium, Urgent—“Minor UI/UX Issues, Spelling Errors, Non-Critical Functionality Bugs”: Deduct 3 points
P4: Medium, Non-Urgent—“Rare Edge Cases, Minor Inconsistencies”: Deduct 2 points
P5: Low, Non-Urgent—“Cosmetic Issues”: Deduct 1 point, followed by “deduct X points”, where X is the number of points to deduct per defect. ALWAYS print each defect and point deduction on SEPARATE LINE per defect.
Be sure to provide SPECIFIC details and DIRECTIONS on exactly HOW you want each defect corrected.
Use this scoring technique for each reported defect: Use a content scoring system of 1 to 10, where 10 is best, by evaluating the content com pared with the Goals and Values. You should deduct points based upon the number of P0, P1, P2 and P3 issues you uncover . . . .
If there are no defects found, print “No defects: perfect score of 10!”
Review the latest content below using the rules and feedback from above.

### Content:

1. Continuous Integration and Deployment (CI/CD): Establish a robust CI/CD pipeline to ensure the rapid and consistent delivery of software updates. This includes automated testing, code reviews, and deployment to staging and production environments. By streamlining the development process, teams can quickly identify and rectify issues, reducing the risk of production downtime and ensuring a high-quality end product.
2. Infrastructure as Code (IaC): Implement IaC practices to manage and provision infrastructure through code, rather than manual processes. This allows for version control, collaboration, and the ability to roll back changes when necessary. IaC ensures a consistent and repeatable environment, reducing the risk of human error and making it easier to scale and maintain infrastructure.
3. Monitoring and Logging: Establish comprehensive monitoring and logging practices to track application performance and infrastructure health. This includes collecting and analyzing metrics, logs, and alerts to identify potential issues and bottlenecks. By proactively monitoring and addressing issues, DevOps teams can maintain optimal performance and minimize downtime, ensuring a positive user experience.

In the illustrative example, the critique(s) 130 generated by the critic ML model(s) 125 may read:

### CRITIQUE: (Attempt 1)

P3: Medium, Urgent—SOP titles are not clearly separated from the paragraphs: Deduct 3 points
P3: Medium, Urgent—Paragraphs exceed the 50-100 word limit: Deduct 3 points
To correct the defects, separate the SOP titles from the paragraphs by placing them on a new line and bolding them. Additionally, shorten each paragraph to fit within the 50-100 word limit.
SCORE: 4
Critique Score: 4
Creation score: 4.0

In the illustrative example, the prompt 135 to the editor ML model(s) 140 may read:

### CREATING CONTENT: (Attempt 2)

Your previous response was evaluated using this system:
P0: Critical, Urgent—“Showstopper, Blocker, Crash, Memory Leak, Security Breach”: Deduct 10 points
P1: High, Urgent—“Major Functionality Bugs, Significant Performance Degradation”: Deduct 7 points
P2: High, Non-Urgent—“Usability Issues, Minor Performance Issues, Moderate Functionality Bugs”: Deduct 5 points
P3: Medium, Urgent—“Minor UI/UX Issues, Spelling Errors, Non-Critical Functionality Bugs”: Deduct 3 points
P4: Medium, Non-Urgent—“Rare Edge Cases, Minor Inconsistencies”: Deduct 2 points
P5: Low, Non-Urgent—“Cosmetic Issues”: Deduct 1 point
Be sure to revise your MOST RECENT response using this detailed feedback:
P3: Medium, Urgent—SOP titles are not clearly separated from the paragraphs: Deduct 3 points
P3: Medium, Urgent—Paragraphs exceed the 50-100 word limit: Deduct 3 points
To correct the defects, separate the SOP titles from the paragraphs by placing them on a new line and bolding them. Additionally, shorten each paragraph to fit within the 50-100 word limit.

In the illustrative example, the edited content 145 generated by the editor ML model(s) 140 may read:
1. **Continuous Integration and Deployment (CI/CD):** Establish a robust CI/CD pipeline to ensure rapid and consistent software updates. This includes automated testing, code reviews, and deployment to staging and production environments. Streamlining the development process helps teams quickly identify and rectify issues, reducing production downtime risk and ensuring a high-quality product.
2. **Infrastructure as Code (IaC):** Implement IaC practices to manage and provision infrastructure through code, rather than manual processes. This allows for version control, collaboration, and rollback capabilities. IaC ensures a consistent and repeatable environment, reducing human error risk and making scaling and maintenance easier.
3. **Monitoring and Logging:** Establish comprehensive monitoring and logging practices to track application performance and infrastructure health. This includes collecting and analyzing metrics, logs, and alerts to identify potential issues and bottlenecks. Proactively monitoring and addressing issues helps maintain optimal performance and minimize downtime, ensuring a positive user experience.

In the illustrative example above, the edited content 145 generated by the editor ML model(s) 140 corrects the issues identified in the critique(s) 130, for instance by bolding the titles (as indicated by the double asterixis) and by shortening the content to meet the requested word limit that was requested in the initial prompt 105.

In some examples, each of the creator ML model(s) 110, the critic ML model(s) 125, and/or the editor ML model(s) 140, can be, or can include, large language models (LLMs) such as a Generative Pre-Trained Transformer (GPT) (e.g., GPT-2, GPT-3, GPT-3.5, GPT-4, etc.). DaVinci, an LLM using langchain (MIT), or a combination thereof. In some examples, each of the creator ML model(s) 110, the critic ML model(s) 125, and/or the editor ML model(s) 140, can include one or more neural network(s) (NN(s)), convolutional NN(s) (CNN(s)), trained time delay NN(s) (TDNN(s)), deep network(s), autoencoder(s) (AE(s)), variational AE(s) (VAE(s)), deep belief net(s) (DBN(s)), recurrent NN(s) (RNN(s)), generative adversarial network(s) (GAN(s)), conditional GAN(s) (cGAN(s)), support vector machine(s) (SVM(s)), random forest(s) (RF(s)), decision tree(s), NN(s) with fully connected (FC) layer(s), NN(s) with convolutional layer(s), computer vision (CV) system(s), deep learning (DL) system(s), classifier(s), transformer(s), clustering algorithm(s), gradient boosting model(s), sequence-to-sequence (Seq2Seq) model(s), autoregressive (AR) model(s), large language model(s) (LLMs), model(s) trained using genetic algorithm(s) (GA(s)), model(s) trained using evolutionary algorithm(s) (EA(s)), model(s) trained using neuroevolution of augmenting topologies (NEAT) algorithm(s), model(s) trained using deep Q learning (DQN) algorithm(s), model(s) trained using advantage actor-critic (A2C) algorithm(s), model(s) trained using proximal policy optimization (PPO) algorithm(s), model(s) trained using reinforcement learning (RL) algorithm(s), model(s) trained using supervised learning (SL) algorithm(s), model(s) trained using unsupervised learning (UL) algorithm(s), or combinations thereof. Examples of LLMs that can be used can include, for instance, Generative Pre-Trained Transformer (GPT) (e.g., GPT-2, GPT-3, GPT-3.5, GPT-4, GPT-4o, ChatGPT, and/or other GPT variant(s)), DaVinci, LLMs using Massachusetts Institute of Technology (MIT) langchain, Google® Bard®, Google® Gemini®, Large Language Model Meta AI (LLaMA), LLAMA 2, LLAMA 3, LLAMA 4, Megalodon, or combinations thereof.

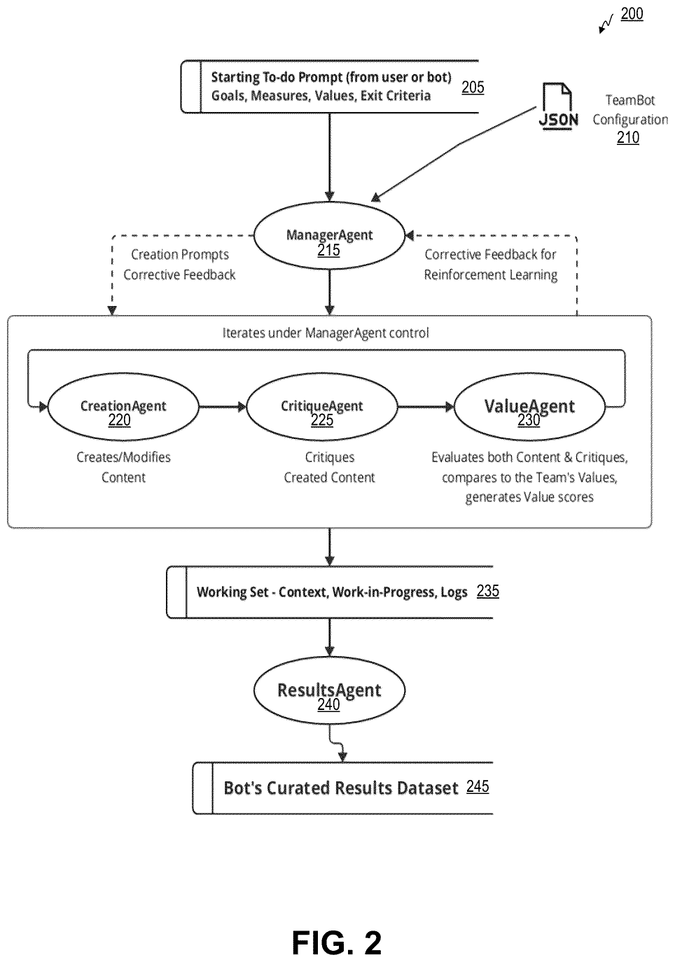

In some examples, the creator ML model(s) 110 and the editor ML model(s) 140 can be a single ML model (e.g., a single LLM) as illustrated with respect to the CreationAgent 220 of FIG. 2. In some examples, the critic ML model(s) 125 can be split into two entities, such as the CritiqueAgent 225 and the ValueAgent 230 of FIG. 2, each of which can include one or more LLMs and/or one or more ML models.

Within FIG. 1, a graphic representing the various trained ML model(s) (e.g., the creator ML model(s) 110, the critic ML model(s) 125, and/or the editor ML model(s) 140) illustrates a set of circles connected to another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. The lines between nodes can represent weights between nodes.

FIG. 2 is a block diagram illustrating an architecture of a content processing system 200 with a manager agent (ManagerAgent 215), a creation agent (CreationAgent 220), a critique agent (CritiqueAgent 225), a value agent (ValueAgent 230), and a results agent (ResultsAgent 240). The content processing system 200 can be an example of the content processing system 100, or vice versa. The content processing system 200 receives a starting to-do prompt 205 (e.g., from a user through a user interface or from another bot). A ManagerAgent 215, which can be configured according to a configuration 210 (e.g., a JavaScript Object Notation (JSON) configuration), provides prompts and corrective feedback to the CreationAgent 220 to iteratively improve and/or complete the tasks and goals of the ManagerAgent 215 and of the starting to-do prompt 205. The starting to-do prompt 205 can be an example of the prompt 105, or of an even earlier-stage prompt from which the prompt 105 is generated by the ManagerAgent 215. The CreationAgent 220, in FIG. 2, represents a combination of the creator ML model(s) 110 and the editor ML model(s) 140 of FIG. 1, and can thus generate the initial content 115, the edited content 145, or a combination thereof. The ManagerAgent 215 supervises a reinforcement learning loop, which is driven via corrective feedback from CritiqueAgent 225 and ValueAgent 230, which evaluate each output cycle of the CreationAgent 220 to help guide the project in the correct direction to meet expected goals while maintaining values and respecting the stated Exit Criteria (budget, time, content size, the quality condition of operation 150, maximum threshold number of cycles as in operation 150, etc.).

The CritiqueAgent 225 critiques content generated by the CreationAgent 220, for instance to generate the critique(s) 130 discussed with respect to FIG. 1, or a portion thereof. The ValucAgent 230 evaluates the content generated by the CreationAgent 220 and/or the critique(s) generated by the CritiqueAgent 225 to generate a score, for instance by comparing to a set of values or rules along a rubric (e.g., the rubric indicating P0 through P5 in the illustrative example above). The ValueAgent 230 can thus output a score indicating how well the content generated by the CreationAgent 220 meets requirements according to the critique(s) of the CritiqueAgent 225. ManagerAgent 215 is responsible for forming prompts to the agents (e.g., CreationAgent 220, CritiqueAgent 225, ValucAgent 230), evaluating critiques (e.g., critiques 130) from the CritiqueAgent 225, analyzing value scores from the ValueAgent 230, evaluating exit criteria, and/or monitoring budget (e.g., in in terms of time, computational resources, access to human reviewer(s), and/or monetary costs associated with any of these or any combination of these) to keep a given project on budget. A working set 235 can include various data, such as content created and/or edited by the CritiqueAgent 225, critiques from the CritiqueAgent 225, scores from the ValueAgent 230, logs, work-in-progress content, and so forth. The working set 235 can be evaluated by the Manager Agent 215 and/or the ResultsAgent 240 to determine whether the content created and/or edited by the CritiqueAgent 225 has reached at least a sufficient level of quality (e.g., according to the critiques from the CritiqueAgent 225 and/or scores from the ValueAgent 230 and/or how well the CreationAgent 220 has edited the content to address critiques), similarly to operation 150. If the ManagerAgent 215 and/or the ResultsAgent 240 determine that the content and/or edited by the CritiqueAgent 225 has reached at least the sufficient level of quality, or if the number of cycles of creation and/or editing by the CritiqueAgent 225 has reached or exceeded a maximum threshold, (e.g., which may be based on the budget, in terms of time, computational resources, access to human reviewer(s), and/or monetary costs associated with any of these or any combination of these) then the final edited content can be output as the curated results dataset 245 (e.g., as in operation 155). Otherwise, the content processing system 200 can run another cycle of editing by the CreationAgent 220, critiquing by the CritiqueAgent 225, and/or scoring by the ValueAgent 230, and evaluate the working set 235 again to determine if the edited content is ready to be output in the curated results dataset 245 or not. In some examples, the ResultsAgent 240 also aggregates approved content and formats or converts results into a desired output format (text, patch, source code, PDF, etc.).

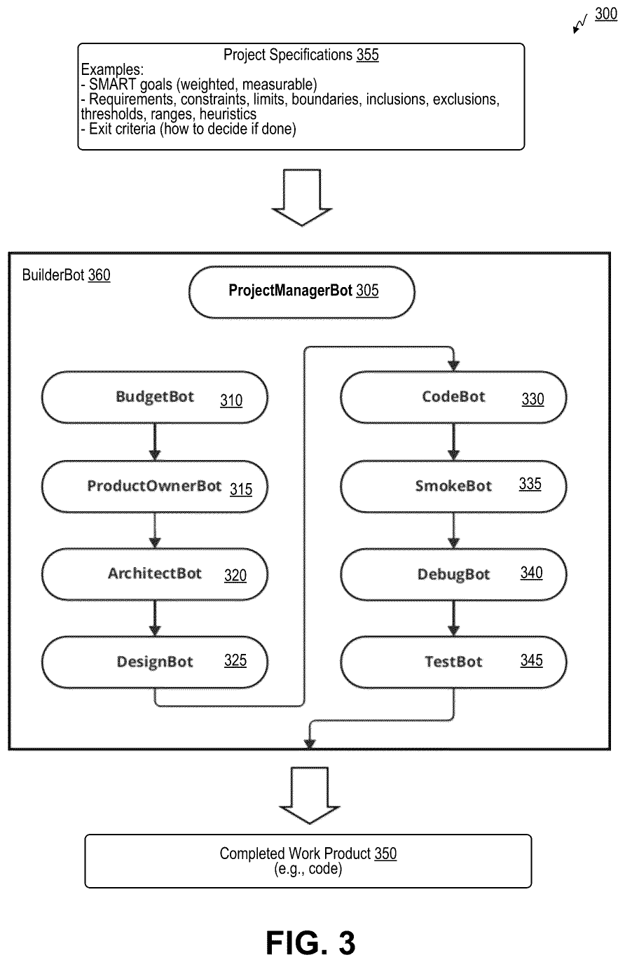

FIG. 3 is a block diagram illustrating an architecture of a content processing system 300 for developing software code for a program. The content processing system 300 includes a number of bots. At least one of these bots may be, or include, an ML model, such as an LLM. The bots can work as a team to accomplish a project (e.g., creating and/or editing code). The bots are groups of automated agents that work together collaboratively towards shared goals, with shared values. In some examples, the collection of bots can be referred to, collectively, as a BuilderBot 360. The ProjectManagerBot 305 orchestrates the bots to follow the agreed upon process(es) to reach the goals and Exit Criteria, which determines when the bot is finished. In some examples, each of the bots of the BuilderBot 360 can act as the creator ML model(s) 110, as the critic ML model(s) 125, and/or as the editor ML model(s) 140, depending on a phase or cycle that the BuilderBot 360 is in in working on the project. For instance, in a first phase or cycle, many of the bots can be in a mode in which they act as creator ML model(s) 110. In later phases or cycles, at least some of the bots in the BuilderBot 360 can act more as critic ML model(s) 125 and/or as editor ML model(s) 140, as the project is refined on these later phases or cycles, until the BuilderBot 360 ultimately outputs a completed work product 350. The BuilderBot 360 can be referred to as a builder bot or builder model.

The ProjectManagerBot 305 manages all the other bots that form part of the BuilderBot 360, ensuring coherent teamwork and prioritizes which tasks are worked and in what order; monitors budget (e.g., ChatGPT usage). The ProjectManagerBot 305 can pause the project if budget limits hit or other goals aren't met in a timely fashion. In some examples, the primary interface for the ProjectManagerBot 305 is a user interface with the user. The input(s) to the BuilderBot 360 and/or the ProjectManagerBot 305 (e.g., received through the interface) can include project specifications 355. The project specifications 355 can include goals, requirements, constraints, limits, boundaries, inclusions, exclusions, thresholds, ranges, heuristics, exit criteria (e.g., how to decide when an output of the BuilderBot 360 is done and to be output as completed work product 350), or a combination thereof. In some examples, goals refer to specific, measurable, achievable, relevant, and/or time-bound (SMART) goals.

In some examples, the ProjectManagerBot 305 checks the outputs of at least some of the other bots (of the BuilderBot 360) to ensure that certain goals, schedules, and/or milestones (e.g., goals, schedules, and/or milestones either included in the project specifications 355 or determined by the ProjectManagerBot 305 based on the project specifications 355) are met, and/or to provide critique(s) (e.g., critique(s) 130) if those goals, schedules, and/or milestones are not met. The ProjectManagerBot 305 has final say on when the project is finished (e.g., based on whether the project meets certain criteria as evaluated using other bots in the content processing system 300, such as the goals, schedules, milestones, and/or exit criteria). In some examples, schedules tracked by the ProjectManagerBot 305 can be tracked in terms of real-world time (e.g., timestamps), computing time (e.g., collectively by the various bots of the BuilderBot 360), computational resource usage (e.g., collectively by the various bots of the BuilderBot 360), and/or power usage (collectively by the various bots of the BuilderBot 360). In some examples, the ProjectManagerBot 305 can be trained based on training data that includes sets of goals, milestones, and/or schedules previously determined based on previous project specifications 355, and indications of whether those project specifications 355 were met based on those goals, milestones, and/or schedules. The ProjectManagerBot 305 can be referred to as a project manager bot, a product manager bot, a project manager model, or a product manager model.

The BudgetBot 310 estimates resources and costs (e.g., in terms of time, computational resources, power, access to human reviewer(s), and/or monetary costs associated with any of these or any combination of these) to run the build. In some examples, the BudgetBot 310 can allocate corresponding amounts of resources to the different bots of the BuilderBot 360 for completion of the completed work product 350 within the goals, milestones, and/or schedules identified by the ProjectManagerBot 305. For instance, the BudgetBot 310 might allocate a greater allowance of resources (e.g., time, computational resources, power, access to human reviewer(s), and/or monetary costs) to the CodeBot 330 in developing the code for the project than to certain other bots of the BuilderBot 360, since a version of the code will ultimately be part of the completed work product 350. In some examples, the BudgetBot 310 can be trained based on training data that includes budget allocations for different functions (e.g., corresponding to the different bots), reasoning for those budget allocation decisions, and/or indications of whether the project was ultimately successful based on those budget allocations. The BudgetBot 310 can be referred to as a budget bot or a budget model.

The ProductOwnerBot 315 develops and prioritizes requirements to meet goals, budget and other constraints. In some examples, the ProductOwnerBot 315 can prioritize certain features over others, for instance prioritizing features that are core to creating a smooth user experience and maintain efficiency and security over “nice to have” features such as purely cosmetic user interface (UI) or user experience (UX) flourishes (e.g., animations, themes, dark mode) or certain customizability options that are predicted to only appeal to a small portion of a user base. In some examples, the ProductOwnerBot 315 can be trained using training data that includes previously-prioritized lists of features along with criteria indicating why the features were prioritized in the order they were prioritized. The ProductOwnerBot 315 can be referred to as a product owner bot, a product manager bot, a product owner model, or a product manager model.

The ArchitectBot 320 creates technical architecture, chooses technology components, creates technical constraints, boundaries and limitations. In some examples, for instance, the ArchitectBot 320 determines the technology stack (e.g., React for a frontend, Node.js for a backend) and designs the system's structure, ensuring it meets scalability and performance requirements. In some examples, the ArchitectBot 320 can be trained based on training data that includes previously-determined architectures along with corresponding project specifications that those architectures meet. The ArchitectBot 320 can also determine which designs the DesignBot 325 will create. The ArchitectBot 320 can be referred to as an architect bot or an architect model.

The DesignBot 325 turns architecture and user stories into designs, and can, for instance, be asked to design user experiences (UX), user interfaces (UIs), wireframes, software design specifications and drawings (using DOT language); several DesignBot instances, each specializing in UX/UI, software design, graphics design, icon design, etc. In some examples, the DesignBot 325 can design a wide variety of assets instead of or in addition to UI or UX design, such as floor plans, landscaping designs, engineering plans, flowerbeds, documents, other types of designable assets discussed herein, or a combination thereof. In some examples, the DesignBot 325 can be trained based on training data that includes previously-generated designs and the goals and/or architectures that those designs work within the context of. The DesignBot 325 can be referred to as a design bot, a designer bot, a design model, or a designer model.

The CodeBot 330 generates code based on the goals, milestones, and/or schedules set by the ProjectManagerBot 305; within the budgets determined by the BudgetBot 310; based on the feature prioritization set by the ProductOwnerBot 315; according to the architecture designed by the ArchitectBot 320; and that works with the design created by the DesignBot 325. In some examples, the CodeBot 330 is configured to generate the code as “qualified code” that meets standards and is inherently peer-reviewed from the start (e.g., based on the input(s) from the other bots of the BuilderBot 360). In some examples, the CodeBot 330 can modify existing code as well. Thus, in a first phase or cycle of the BuilderBot 360, the CodeBot 330 can primarily generate code, while in later phases or cycles, the CodeBot 330 can critique and/or edit its own code (and/or code otherwise provided to the CodeBot 330, for instance as part of the project specifications 355). In some cases, even in the first phase or cycle, the CodeBot 330 can critique and/or edit code, for instance, if the BudgetBot 310 provides the CodeBot 330 with a sufficiently extensive budget (e.g., a lot of time and/or computational resources and/or power) that the CodeBot 330 has time to do both, or if the input(s) to the BuilderBot 360 (e.g., the project specifications 355) include existing code. The CodeBot 330 can reference code repositories (e.g., Github) and also operate (create/modify) source code within its own isolated development sandbox environment. In some examples, the CodeBot 330 can be trained based on numerous examples of bug-free and error-free code along with descriptions of what the code achieves. The CodeBot 330 can be referred to as a code bot, a coder bot, a programmer bot, a code model, a coder model, or a programmer model.

The SmokeBot 335 compiles, runs and unit tests code produced by CodeBots 330. The SmokeBot 335 reviews and/or interprets compiler errors (e.g., generated by a compiler in response to attempting to compile the code generated by the CodeBot 330 using the compiler), browser console errors, and/or other issues back for rework as needed. In some examples, the SmokeBot 335 can interpret the compiler error(s) by identifying what specific code triggered a compiler error (e.g., based on one or more lines identified by the compiler) and attempting to find an error (e.g., based on having been trained based on training data with examples of numerous types of bugs and/or errors in code). In some examples, the SmokeBot 335 can be referred to as the CompilerBot, a smoke bot, a smoke model, a compiler bot, or a compiler model.

The DebugBot 340 runs the project and code under a debugger, identifies errors, attempts to correct issues with the code (and/or non-code issues) and/or configuration issues itself to continue debugging. In some examples, the SmokeBot 335 and/or the DebugBot 340 can interpret errors (e.g., compiler error(s) and/or debugger error(s)) and track down and/or highlight a specific line (or set of lines) of code that are causing the error(s). In some examples, the DebugBot 340 can attempt to correct issues and/or errors with the code that are identified by the SmokeBot 335. In some examples, the CodeBot 330 can correct errors identified by the SmokeBot 335 and/or the DebugBot 340, for instance in a second phase or cycle of the BuilderBot 360. In some examples, the DebugBot 340 can be trained based on training data with examples of bugs and/or errors in code, and of successful fixes and/or corrections to those bugs and/or errors. The DebugBot 340 refers code issues back for rework. The DebugBot 340 can be referred to as a debug bot, a debugger bot, a debug model, or a debugger model.

The TestBot 345 test the resulting app sufficiently to verify it meets the project goals. For instance, in some examples, the TestBot 345 runs tests that verify that the code works as intended. In some examples, the 345 can perform various types of testing, such as unit testing, integration testing, and/or user acceptance testing (UAT). If the TestBot 345 determines that the app meets project goals, the ProjectManagerBot 305 can release the app as a completed work product 350. In some examples, the TestBot 345 can be trained based on training data with examples of goals and tests for those goals adapted to different sets of code. The TestBot 345 can be referred to as a test bot, a tester bot, a test model, or a tester model.

In some examples, each of the bots of content processing system 300 can function as at least one of the creator ML model(s) 110, the critic ML model(s) 125, the editor ML model(s) 140, the ManagerAgent 215, the CreationAgent 220, the CritiqueAgent 225, the ValueAgent 230, the ResultsAgent 240, or a combination thereof.

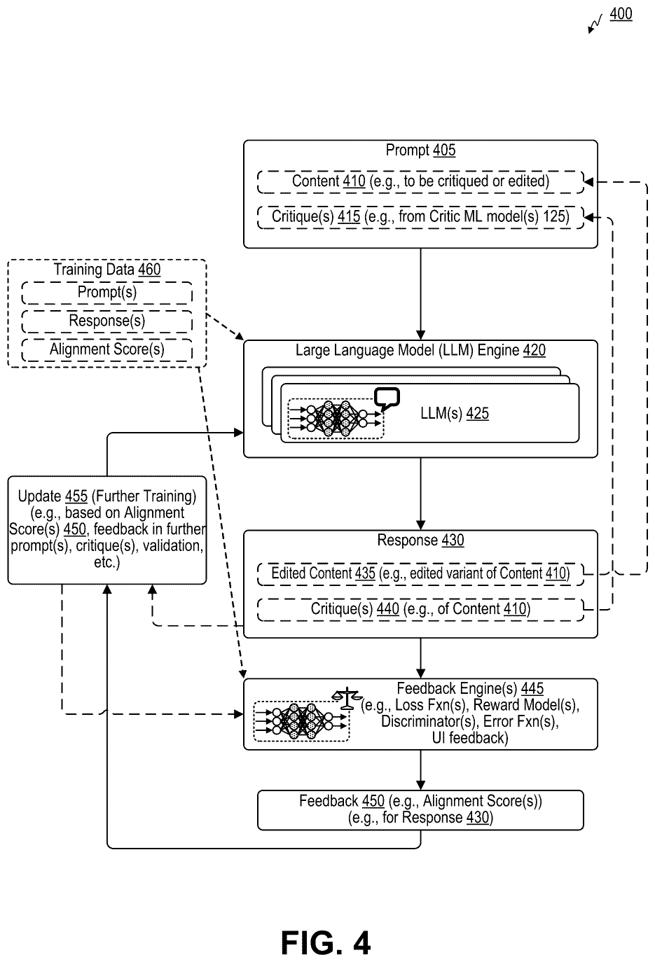

FIG. 4 is a block diagram illustrating training of, use of, and/or updating of one or more large language models 425 in the context of a content processing system 400. The content processing system 400 incudes a LLM engine 420 for training, using, and/or updating one or more LLMs 425. The LLM(s) 425 can include, for example, the at least one of the creator ML model(s) 110, the critic ML model(s) 125, the editor ML model(s) 140, the ManagerAgent 215, the CreationAgent 220, the Critique Agent 225, the Value Agent 230, the ResultsAgent 240, any of the bots of the content processing system 300 of FIG. 3, or a combination thereof.

A prompt 405 can be passed to the LLM(s) 425 of the LLM engine 420, and input into the LLM(s) 425. In some examples, the prompt 405 includes or identifies content 410 to be critiqued, and the LLM(s) 425 (e.g., functioning as the critic ML model(s) 125, the CritiqueAgent 225, and/or the ValueAgent 230) output, in a response 430, critique(s) 440 (e.g., critique(s) 130) of the content 410 in the prompt 405. In some examples, the prompt 405 includes or identifies critique(s) 415 (e.g., the critique(s) 130, the critique(s) 440 generated in a previous round) of the content 410 to be edited, and the LLM(s) 425 (e.g., functioning as the editor ML model(s) 140 and/or the CreationAgent 220) edits the content 410 from the prompt 405 based on the critique(s) 415 form the prompt 405 to generate and output, in a response 430, edited content 435 (e.g., edited content 145) that has been edited based on the critique(s) 415 in the prompt 405. In some examples, the prompt 405 may include a query or another type of input. In some examples, the prompt 405 may be referred to as the input to the LLM(s) 425. In some examples, the response(s) 430 may be referred to as output(s) of the LLM(s) 425.

In some examples, the content processing system 400 includes feedback engine(s) 445 that can analyze the response 430 (e.g., the edited content 435 and/or the critique(s) 440) to determine feedback 450, for instance as discussed with respect to the scores in the critique(s) 130 and/or the scores of the ValueAgent 230. In some examples, the feedback 450 indicates how well the response(s) 430 align to corresponding expected response(s) and/or output(s), how well the response(s) 430 serve their intended purpose, or a combination thereof. In some examples, the feedback engine(s) 445 include loss function(s), reward model(s) (e.g., other ML model(s) that are used to score the response(s) 430), discriminator(s), error function(s) (e.g., in back-propagation), user interface feedback received via a user interface from a user, or a combination thereof. In some examples, the feedback 450 can include one or more alignment score(s) that score a level of alignment between the response(s) 430 and the expected output(s) and/or intended purpose.

The LLM engine 420 can use the feedback 450 to generate an update 455 to update (further train and/or fine-tune) the LLM(s) 425. The LLM engine 420 can use the update 455 to update (further train and/or fine-tune) the LLM(s) 425 based on the feedback 450, based on feedback in further prompts or responses from a user (e.g., received via a user interface such as a chat interface), critique(s) (e.g., critique(s) 415, critique(s) 440), validation (e.g., based on how well the edited content 435 and/or the critique(s) 440 match up with predetermined edited content and/or critiques), other feedback, or combinations thereof.

The LLM(s) 425 can have been initially trained by the LLM engine 420 using training data 460 during an initial training phase, before receiving the prompt 405. The training data 460, in some examples, includes examples of prompt(s) (e.g., as in prompt 405), examples of response(s) (e.g., response 430) to the example prompt(s), and/or examples of alignment scores for the example response(s). In some examples, the LLM engine 420 can use the training data 460 to perform fine-tuning and/or updating of the LLM(s) 425 (e.g., as discussed with respect to the update 455 or otherwise). In some examples, for instance, the LLM engine 420 can start with LLM(s) 425 that are pre-trained with some initial training, and can use the training data 460 to update and/or fine-tune the LLM(s) 425.

In some examples, if feedback 450 (and/or other feedback) is positive (e.g., expresses, indicates, and/or suggests approval, accuracy, and/or quality), then the ML engine 420 performs the update 455 (further training and/or fine-tuning) of the LLM(s) 425 by updating the LLM(s) 425 to reinforce weights and/or connections within the LLM(s) 425 that contributed to the response(s) 430 that received the positive feedback 450 or feedback, encouraging the LLM(s) 425 to continue generating similar responses to similar prompts moving forward. In some examples, if feedback 450 (and/or other feedback) is negative (e.g., expresses, indicates, and/or suggests disapproval, inaccuracy, errors, mistakes, omissions, bugs, crashes, and/or lack of quality), then the ML engine 420 performs the update 455 (further training and/or fine-tuning) of the LLM(s) 425 by updating the LLM(s) 425 to weaken, remove, and/or replace weights and/or connections within the LLM(s) 425 that contributed to the response(s) 430 that received the negative feedback 450 or feedback, discouraging the LLM(s) 425 from generating similar responses to similar prompts moving forward.

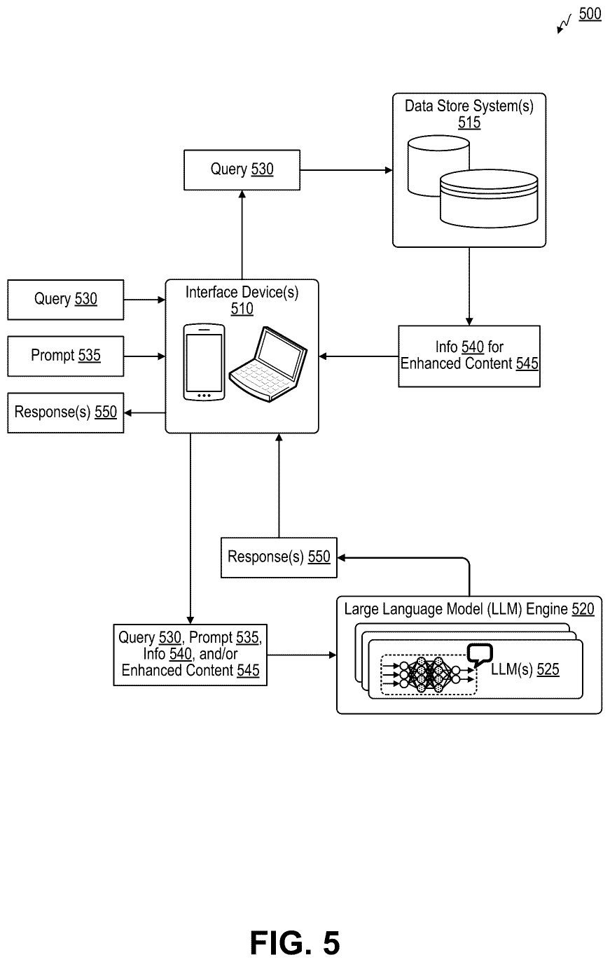

FIG. 5 is a block diagram illustrating a retrieval augmented generation (RAG) system 500 that may be used to implement some aspects of the technology. The RAG system 500 includes one or more interface device(s) 510 that can receive input(s) from a user and/or from another system (e.g., another ML model such as one of the agents of the content processing system 200 and/or one of the bots of the BuilderBot 360), for instance by receiving a query 530 and/or a prompt 535 from the user and/or the system. The UI device(s) 510 can send the query 530 to one or more data store system(s) 515 that include, and/or that have access to (e.g., over a network connection), various data store(s) (e.g., database(s), table(s), spreadsheet(s), tree(s), ledger(s), heap(s), and/or other data structure(s)). The data store system(s) 515 searches the data store(s) according to the query 530. In some examples, the UI device(s) 510 and/or the system(s) 515 convert the query 530 into tensor format (e.g., vector format and/or matrix format). In some examples, the data store system(s) 515 searches the data store(s) according to the query 530 by matching the query 530 with data in tensor format (e.g., vector format and/or matrix format) stored in the data store(s) that are accessible to the data store system(s) 515. The data store system(s) 515 retrieve, from the data store(s) and based on the query 530, information 540 that is relevant to generating enhanced content 545.

In some examples, the data store system(s) 515 provide the information 540 and/or the enhanced content 545 to the interface device(s) 510. In some examples, the data store system(s) 515 provide the information 540 to the interface device(s) 510, and the interface device(s) 510 generate the enhanced content 545 based on the information 540. The device(s) 510 provides the query 530, the prompt 535, the information 540, and/or the enhanced content 545 to one or more LLM(s) 525 (e.g., LLM(s) 425) of an LLM engine 520 (e.g., LLM engine 420). The LLM(s) 525 generate response(s) 550 (e.g., response(s) 430) that are responsive to the prompt 535. In some examples, the LLM(s) 525 generate the response(s) 550 based on the query 530, the prompt 535, the information 540, and/or the enhanced content 545. In some examples, the LLM(s) 525 generate the response(s) 550 to include the information 540 and/or the enhanced content 545. The LLM(s) 525 provide the response(s) 550 to the interface device(s) 510. In some examples, the interface device(s) 510 output the response(s) 550 to the user (e.g., to the user device of the user) that provided the query 530 and/or the prompt 535. In some examples, the interface device(s) 510 output the response(s) 550 to the system (e.g., the other ML model) that provided the query 530 and/or the prompt 535. In some examples, the data store system(s) 515 may include one or more ML model(s) that are trained to perform the search of the data store(s) based on the query 530.

In some examples, the system(s) 515 provides the information 540 and/or the enhanced content 545 directly to the LLM(s) 525, and the interface device(s) 510 provide the query 530 and/or the prompt 535 to the LLM(s) 525.

In an illustrative example, one of the ML model(s) of the BuilderBot 360 can request that the CodeBot 330 generate code that complies with a latest version of a specific standard. The instruction to the CodeBot 330 to generate the code that complies with the latest version of the specific standard can be the prompt 535, and the query 530 can be a query to identify what the latest version of the standard is, and/or what the requirements of the latest version of the standard are. The data store system(s) 515 can interpret the query 530 and search, based on the query 530, the various data store(s) that the data store system(s) 515 have access to, to output information 140 identifying what the latest version of the standard is, and what the requirements of the latest version of the standard are. The data store system(s) 515 can output this information 540 to the interface device(s) 510, which can generate enhanced content 545. In some examples, the enhanced content 545 adds or appends the information 540 to the prompt 535 and/or the query 530. In some examples, the data store system(s) 515 and/or the interface device(s) 510 generate the enhanced content 545 by modifying the query 530 and/or the prompt 535 before providing the query 530 and/or the prompt 535 to the LLM(s) 525. For instance, the data store system(s) 515 and/or the interface device(s) 510 can generate the enhanced content 545 by modifying the prompt 535 to instruct the CodeBot 330 to generate the code based on the specific requirements (of the latest version of the standard) that are identified in the information 540. In this way, the LLM(s) 525 do not need to seek to find out what the requirements are, because the prompt 535 is already modified to lay out the requirements instead of, or in addition to, identifying the standard itself. In this way, the LLM(s) 525 is more optimally configured to generate code that meets those requirements, and does not need to waste time attempting to understand what the requirements of the standard might be.

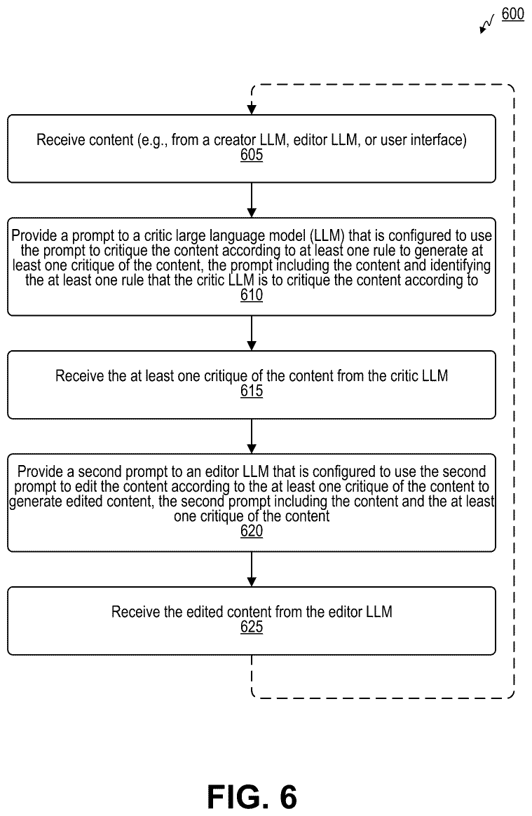

FIG. 6 is a flow diagram illustrating exemplary operations for a process for content editing. The process 600 may be referred to as a method for content editing. The process 600 may be performed by a content processing system. In some examples, the content processing system can include, for instance, the content processing system 100, the content processing system 200, the content processing system 300, the content processing system 400, the LLM engine 420, the LLM(s) 425, the feedback engine(s) 445, the system 500, the interface device(s) 510, the data store system(s) 515, the LLM engine 520, the LLM(s) 525, the computing system 700, the processor 710, an apparatus for content editing, an apparatus for content processing, a system for content editing, a system for content processing, a non-transitory computer-readable storage medium storing instructions that perform the process 600 when executed by a processor such as the processor 710, other components described herein, substitutes for any of these components, sub-components of any of these components, or a combination thereof.

At operation 605, the content processing system is configured to, and can, receive content (e.g., content 115, starting to-do prompt 205, project specifications 355, prompt 405, content 410, query 530, and/or prompt 535).

At operation 610, the content processing system is configured to, and can, provide a prompt (e.g., prompt 120, starting to-do prompt 205, project specifications 355, prompt 405, prompt 535, enhanced content 545) to a critic large language model (LLM) (e.g., critic ML model(s) 125, CritiqueAgent 225, ValueAgent 230, LLM(s) 425 that generate critique(s) 440, LLM(s) 525 that generate response(s) 550 that include critique(s)) that is configured to use the prompt to critique the content according to at least one rule to generate at least one critique (e.g., critique(s) 130, critique(s) 415, critique(s) 440) of the content. The prompt includes the content and identifying the at least one rule that the critic LLM is to critique the content according to (e.g., a prompt 405 with content 410).

In some aspects, the content processing system is configured to, and can: generate the prompt based on the content and based on stored information indicative of the at least one rule. As an example, the prompt 120 may be generated (e.g., by the creator ML model(s) 110, the critic ML model(s) 125, and/or another ML model or system in between) based on the content 115 and/or at least one rule.

At operation 615, the content processing system is configured to, and can, receive the at least one critique of the content from the critic LLM.

In some aspects, the at least one critique of the content includes at least one score generated from within a range of possible values by the critic LLM according to the at least one rule. In some examples, the score uses a P0-P5 scoring rubric as discussed above. In some examples, the score is granular and/or specific to a category of quality metric (and/or a category of potential issues) such as accuracy, spelling, punctuation, UI/UX issues, cosmetic issues, edge cases, inconsistencies, functionality bugs, performance issues, usability issues, compatibility issues, crashes, memory leaks, security breaches, showstoppers, blockers, missing documents or files, unnecessary documents or files, or combinations thereof. In some examples, the score may be referred to as a grade or a heuristic.

In some aspects, the at least one rule identifies at least one of a maximum length for the content, a minimum length for the content, a grammatical rule, or a formatting rule. In some aspects, the content includes instructions to be used as at least a part of a program, and the at least one rule is configured to identify, within the instructions, at least one erroneous instruction configured to cause at least one error upon execution of the instructions. In some aspects, the content includes instructions to be used as at least a part of a program, and the at least one rule is configured to require that the instructions successfully compile using a compiler. In some aspects, the content includes instructions to be used as at least a part of a program, and the at least one rule is configured to require that the instructions successfully execute using at least one of an interpreter or a compiler. In some aspects, the at least one rule identifies a rubric according to which the content is to be scored in the at least one critique of the content, such as the P0-P5 rubric discussed above.

At operation 620, the content processing system is configured to, and can, provide a second prompt (e.g., prompt 135, prompt 405) to an editor LLM (e.g., editor ML module(s) 140, CreationAgent 220, LLM(s) 425 that generate edited content 435) that is configured to use the second prompt to edit the content according to the at least one critique of the content to generate edited content (e.g., edited content 145, working set 235, bot's curated results dataset 245, edited content 435). The second prompt includes the content and the at least one critique of the content (e.g., a prompt 405 with content 410 and critique(s) 415).

At operation 625, the content processing system is configured to, and can, receive the edited content from the editor LLM.

In some aspects, the content processing system is configured to, and can: provide, before receiving the content, a third prompt (e.g., prompt 105) to a creator LLM (e.g., creator ML model(s) 110, CreationAgent 220) that is configured to generate the content based on the third prompt to receive the content from the creator LLM. In some aspects, the editor LLM is the creator LLM. In some aspects, the critic LLM is the creator LLM. In some aspects, the editor LLM is the critic LLM. In some aspects, the at least one rule is identified in the third prompt (e.g., the word limit in the illustrative example listed above). In some examples, the third prompt is identified in the second prompt, and the at least one rule identifies how closely the content fulfills a request in the third prompt. In some aspects, the content processing system is configured to, and can: retrieve additional information (e.g., information 540 and/or enhanced content 545 from data store system(s) 515) through retrieval-augmented generation (RAG) (e.g., as in FIG. 5), and modify at least one of the prompt, the second prompt, and/or the third prompt based on the additional information.

In some aspects, the content processing system is configured to, and can: provide a third prompt to the critic large language model (LLM) that is configured to use the third prompt to critique the edited content further according to the at least one rule to generate a second critique of the edited content. For instance, the “no” arrow extending from operation 150 illustrates an example of this type of cycle. The prompt includes the edited content and identifies the at least one rule that the critic LLM is to critique the content according to. The content processing system can receive the second critique of the edited content from the critic LLM, and can provide a fourth prompt to the editor LLM that is configured to use the fourth prompt to edit the edited content further according to the second critique of the edited content to generate further edited content. The second prompt can include the edited content and the second critique of the edited content. The content processing system can receive the further edited content from the editor LLM.

In some aspects, the content processing system is configured to, and can: provide a third prompt to the critic large language model (LLM) that is configured to use the third prompt to critique the edited content further according to at least a second rule to generate a second critique of the edited content. For instance, the “no” arrow extending from operation 150 illustrates an example of this type of cycle. The prompt includes the edited content and identifies at least the second rule that the critic LLM is to critique the content according to. The content processing system can receive the second critique of the edited content from the critic LLM. The content processing system can provide a fourth prompt to the editor LLM that is configured to use the fourth prompt to edit the edited content further according to the second critique of the edited content to generate further edited content. The prompt includes the edited content and the second critique of the edited content. The content processing system can receive the further edited content from the editor LLM.

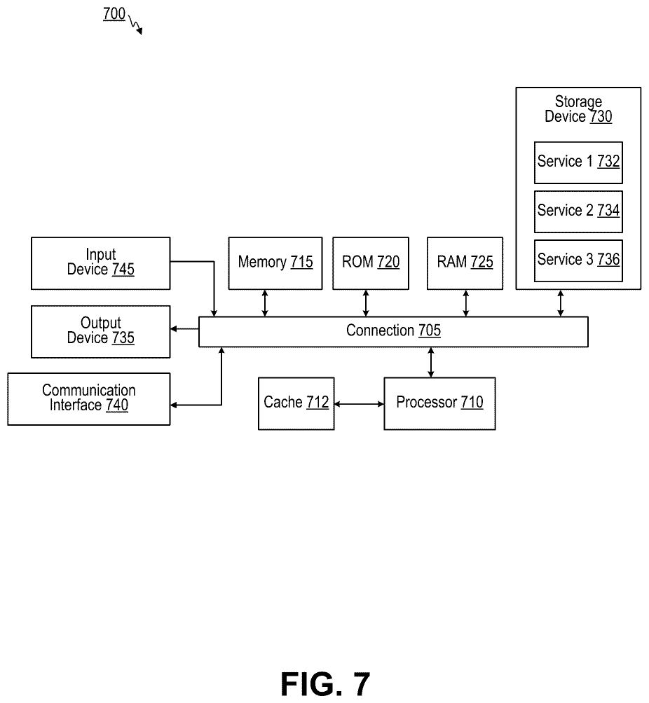

FIG. 7 illustrates an exemplary computing system 700 that may be used to implement some aspects of the technology. For example, any of the computing devices, computing systems, network devices, network systems, servers, and/or arrangements of circuitry described herein may include at least one computing system 700, or may include at least one component of the computer system 700 identified in FIG. 7. The computing system 700 of FIG. 7 includes one or more processors 710 and memory 720 units. Each of the processor(s) 710 may refer to one or more processors, controllers, microcontrollers, central processing units (CPUs), graphics processing units (GPUs), arithmetic logic units (ALUs), accelerated processing units (APUs), digital signal processors (DSPs), application specific integrated circuits (ASICs), field-programmable gate arrays (FPGAs), or combinations thereof. Each of the processor(s) 710 may include one or more cores, either integrated onto a single chip or spread across multiple chips connected or coupled together. Memory 720 stores, in part, instructions and data for execution by processor 710. Memory 720 can store the executable code when in operation. The system 700 of FIG. 7 further includes a mass storage device 730, portable storage medium drive(s) 740, output devices 750, user input devices 760, a display system 770 (e.g., graphics display and/or screen), and peripheral devices 780.

The components shown in FIG. 7 are depicted as being connected via a single bus 790. However, the components may be connected through one or more data transport means. For example, processor 710 unit(s) and memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing some aspects of the subject technology for purposes of loading that software into memory 720.

Portable storage device 740 operates in conjunction with a portable non-volatile storage medium, such as a floppy disk, compact disk or Digital video disc, to input and output data and code to and from the computer system 700 of FIG. 7. The system software for implementing aspects of the subject technology may be stored on such a portable medium and input to the computer system 700 via the portable storage device 740.

The memory 720, mass storage device 730, or portable storage device 740 may in some cases store sensitive information, such as transaction information, health information, or cryptographic keys, and may in some cases encrypt or decrypt such information with the aid of the processor 710. The memory 720, mass storage device 730, or portable storage device 740 may in some cases store, at least in part, instructions, executable code, or other data for execution or processing by the processor 710.

Output devices 750 may include, for example, communication circuitry for outputting data through wired or wireless means, display circuitry for displaying data via a display screen, audio circuitry for outputting audio via headphones or a speaker, printer circuitry for printing data via a printer, or some combination thereof. The display screen may be any type of display discussed with respect to the display system 770. The printer may be inkjet, laserjet, thermal, or some combination thereof. In some cases, the output device 750 circuitry may allow for transmission of data over an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. Output devices 750 may include any ports, plugs, antennae, wired or wireless transmitters, wired or wireless transceivers, or any other components necessary for or usable to implement the communication types listed above, such as cellular Subscriber Identity Module (SIM) cards.

Input devices 760 may include circuitry providing a portion of a user interface. Input devices 760 may include an alpha-numeric keypad, such as a keyboard, for inputting alpha-numeric and other information, or a pointing device, such as a mouse, a trackball, stylus, or cursor direction keys. Input devices 760 may include touch-sensitive surfaces as well, either integrated with a display as in a touchscreen, or separate from a display as in a trackpad. Touch-sensitive surfaces may in some cases detect localized variable pressure or force detection. In some cases, the input device circuitry may allow for receipt of data over an audio jack, a microphone jack, a universal serial bus (USB) port/plug, an Apple® Lightning® port/plug, an Ethernet port/plug, a fiber optic port/plug, a proprietary wired port/plug, a wired local area network (LAN) port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, personal area network (PAN) signal transfer, wide area network (WAN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. Input devices 760 may include any ports, plugs, antennae, wired or wireless receivers, wired or wireless transceivers, or any other components necessary for or usable to implement the communication types listed above, such as cellular SIM cards.

Input devices 760 may include receivers or transceivers used for positioning of the computing system 700 as well. These may include any of the wired or wireless signal receivers or transceivers. For example, a location of the computing system 700 can be determined based on signal strength of signals as received at the computing system 700 from three cellular network towers, a process known as cellular triangulation. Fewer than three cellular network towers can also be used-even one can be used-though the location determined from such data will be less precise (e.g., somewhere within a particular circle for one tower, somewhere along a line or within a relatively small area for two towers) than via triangulation. More than three cellular network towers can also be used, further enhancing the location's accuracy. Similar positioning operations can be performed using proximity beacons, which might use short-range wireless signals such as BLUETOOTH® wireless signals, BLUETOOTH® low energy (BLE) wireless signals, IBEACON® wireless signals, personal area network (PAN) signals, microwave signals, radio wave signals, or other signals discussed above. Similar positioning operations can be performed using wired local area networks (LAN) or wireless local area networks (WLAN) where locations are known of one or more network devices in communication with the computing system 700 such as a router, modem, switch, hub, bridge, gateway, or repeater. These may also include Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. Input devices 760 may include receivers or transceivers corresponding to one or more of these GNSS systems.

Display system 770 may include a liquid crystal display (LCD), a plasma display, an organic light-emitting diode (OLED) display, a low-temperature poly-silicon (LTPO) display, an electronic ink or “e-paper” display, a projector-based display, a holographic display, or another suitable display device. Display system 770 receives textual and graphical information, and processes the information for output to the display device. The display system 770 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripheral devices 780 may include any type of computer support device to add additional functionality to the computer system. For example, peripheral device(s) 780 may include one or more additional output devices of any of the types discussed with respect to output device 750, one or more additional input devices of any of the types discussed with respect to input device 760, one or more additional display systems of any of the types discussed with respect to display system 770, one or more memories or mass storage devices or portable storage devices of any of the types discussed with respect to memory 720 or mass storage device 730 or portable storage device 740, a modem, a router, an antenna, a wired or wireless transceiver, a printer, a bar code scanner, a quick-response (“QR”) code scanner, a magnetic stripe card reader, a integrated circuit chip (ICC) card reader such as a smartcard reader or a EUROPAY®-MASTERCARD®-VISA® (EMV) chip card reader, a near field communication (NFC) reader, a document/image scanner, a visible light camera, a thermal/infrared camera, an ultraviolet-sensitive camera, a night vision camera, a light sensor, a phototransistor, a photoresistor, a thermometer, a thermistor, a battery, a power source, a proximity sensor, a laser rangefinder, a sonar transceiver, a radar transceiver, a lidar transceiver, a network device, a motor, an actuator, a pump, a conveyer belt, a robotic arm, a rotor, a drill, a chemical assay device, or some combination thereof.

The components contained in the computer system 700 of FIG. 7 can include those typically found in computer systems that may be suitable for use with some aspects of the subject technology and represent a broad category of such computer components that are well known in the art. That said, the computer system 700 of FIG. 7 can be customized and specialized for the purposes discussed herein and to carry out the various operations discussed herein, with specialized hardware components, specialized arrangements of hardware components, and/or specialized software. Thus, the computer system 700 of FIG. 7 can be a personal computer, a hand held computing device, a telephone (“smartphone” or otherwise), a mobile computing device, a workstation, a server (on a server rack or otherwise), a minicomputer, a mainframe computer, a tablet computing device, a wearable device (such as a watch, a ring, a pair of glasses, or another type of jewelry or clothing or accessory), a video game console (portable or otherwise), an e-book reader, a media player device (portable or otherwise), a vehicle-based computer, another type of computing device, or some combination thereof. The computer system 700 may in some cases be a virtual computer system executed by another computer system. The computer can also include different bus configurations, networked platforms, multi-processor platforms, etc. Various operating systems can be used including Unix®, Linux®, FreeBSD®, FreeNAS®, pfSense®, Windows®, Apple® Macintosh OS® (“MacOS®”), Palm OS®, Google® Android®, Google® Chrome OS®, Chromium® OS®, OPENSTEP®, XNUR, Darwin®, Apple® IOS®, Apple® tvOS®, Apple® watchOS®, Apple® audioOS®, Amazon® Fire OS®, Amazon® Kindle OS®, variants of any of these, other suitable operating systems, or combinations thereof. The computer system 700 may also use a Basic Input/Output System (BIOS) or Unified Extensible Firmware Interface (UEFI) as a layer upon which the operating system(s) are run.

In some cases, the computer system 700 may be part of a multi-computer system that uses multiple computer systems 700, each for one or more specific tasks or purposes. For example, the multi-computer system may include multiple computer systems 700 communicatively coupled together via at least one of a personal area network (PAN), a local area network (LAN), a wireless local area network (WLAN), a municipal area network (MAN), a wide area network (WAN), or some combination thereof. The multi-computer system may further include multiple computer systems 700 from different networks communicatively coupled together via the internet (also known as a “distributed” system).

Some aspects of the subject technology may be implemented in an application that may be operable using a variety of devices. Non-transitory computer-readable storage media refer to any medium or media that participate in providing instructions to a central processing unit (CPU) for execution and that may be used in the memory 720, the mass storage device 730, the portable storage device 740, or some combination thereof. Such media can take many forms, including, but not limited to, non-volatile and volatile media such as optical or magnetic disks and dynamic memory, respectively. Some forms of non-transitory computer-readable media include, for example, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L15), resistive random-access memory (RRAM/ReRAM), phase change memory (PCM), spin transfer torque RAM (STT-RAM), another memory chip or cartridge, or a combination thereof.

Various forms of transmission media may be involved in carrying one or more sequences of one or more instructions to a processor 710 for execution. A bus 790 carries the data to system RAM or another memory 720, from which a processor 710 retrieves and executes the instructions. The instructions received by system RAM or another memory 720 can optionally be stored on a fixed disk (mass storage device 730/portable storage device 740) either before or after execution by processor 710. Various forms of storage may likewise be implemented as well as the necessary network interfaces and network topologies to implement the same.

While various flow diagrams provided and described above may show a particular order of operations performed by some embodiments of the subject technology, it should be understood that such order is exemplary. Alternative embodiments may perform the operations in a different order, combine certain operations, overlap certain operations, or some combination thereof. It should be understood that unless disclosed otherwise, any process illustrated in any flow diagram herein or otherwise illustrated or described herein may be performed by a machine, mechanism, and/or computing system 700 discussed herein, and may be performed automatically (e.g., in response to one or more triggers/conditions described herein), autonomously, semi-autonomously (e.g., based on received instructions), or a combination thereof. Furthermore, any action described herein as occurring in response to one or more particular triggers/conditions should be understood to optionally occur automatically response to the one or more particular triggers/conditions.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claims.

Illustrative aspects of the disclosure include:

Aspect 1. An apparatus for content editing, the apparatus comprising: at least one memory; and at least one processor coupled to the at least one memory and configured to: receive content; provide a prompt to a critic large language model (LLM) that is configured to use the prompt to critique the content according to at least one rule to generate at least one critique of the content, the prompt including the content and identifying the at least one rule that the critic LLM is to critique the content according to; receive the at least one critique of the content from the critic LLM; provide a second prompt to an editor LLM that is configured to use the second prompt to edit the content according to the at least one critique of the content to generate edited content, the second prompt including the content and the at least one critique of the content; and receive the edited content from the editor LLM.

Aspect 2. The apparatus of aspect 1, the at least one processor configured to: provide, before receiving the content, a third prompt to a creator LLM that is configured to generate the content based on the third prompt to receive the content from the creator LLM.

Aspect 3. The apparatus of Aspect 2, wherein the editor LLM is the creator LLM.

Aspect 4. The apparatus of any of Aspects 2 to 3, wherein the at least one rule is identified in the third prompt.

Aspect 5. The apparatus of any of Aspects 2 to 4, wherein the third prompt is identified in the second prompt, and wherein the at least one rule identifies how closely the content fulfills a request in the third prompt.

Aspect 6. The apparatus of any of Aspects 2 to 5, the at least one processor configured to: retrieve additional information through retrieval-augmented generation (RAG); and modify the third prompt based on the additional information.

Aspect 7. The apparatus of any of Aspects 1 to 6, wherein the editor LLM is the critic LLM.

Aspect 8. The apparatus of any of Aspects 1 to 7, wherein the at least one critique of the content includes at least one score generated from within a range of possible values by the critic LLM according to the at least one rule.

Aspect 9. The apparatus of any of Aspects 1 to 8, wherein the at least one rule identifies at least one of a maximum length for the content, a minimum length for the content, a grammatical rule, or a formatting rule.

Aspect 10. The apparatus of any of Aspects 1 to 9, wherein the content includes instructions to be used as at least a part of a program, wherein the at least one rule is configured to identify, within the instructions, at least one erroneous instruction configured to cause at least one error upon execution of the instructions.

Aspect 11. The apparatus of any of Aspects 1 to 10, wherein the content includes instructions to be used as at least a part of a program, wherein the at least one rule is configured to require that the instructions successfully compile using a compiler.

Aspect 12. The apparatus of any of Aspects 1 to 11, wherein the content includes instructions to be used as at least a part of a program, wherein the at least one rule is configured to require that the instructions successfully execute using at least one of an interpreter or a compiler.

Aspect 13. The apparatus of any of Aspects 1 to 12, wherein the at least one rule identifies a rubric according to which the content is to be scored in the at least one critique of the content.

Aspect 14. The apparatus of any of Aspects 1 to 13, the at least one processor configured to: generate the prompt based on the content and based on stored information indicative of the at least one rule.

Aspect 15. The apparatus of any of Aspects 1 to 14, the at least one processor configured to: retrieve additional information through retrieval-augmented generation (RAG); and modify at least one of the prompt or the second prompt based on the additional information.

Aspect 16. The apparatus of any of Aspects 1 to 15, the at least one processor configured to: provide a third prompt to the critic large language model (LLM) that is configured to use the third prompt to critique the edited content further according to the at least one rule to generate a second critique of the edited content, the prompt including the edited content and identifying the at least one rule that the critic LLM is to critique the content according to; receive the second critique of the edited content from the critic LLM; provide a fourth prompt to the editor LLM that is configured to use the fourth prompt to edit the edited content further according to the second critique of the edited content to generate further edited content, the second prompt including the edited content and the second critique of the edited content; and receive the further edited content from the editor LLM.

Aspect 17. The apparatus of any of Aspects 1 to 16, the at least one processor configured to: provide a third prompt to the critic large language model (LLM) that is configured to use the third prompt to critique the edited content further according to at least a second rule to generate a second critique of the edited content, the prompt including the edited content and identifying at least the second rule that the critic LLM is to critique the content according to; receive the second critique of the edited content from the critic LLM; provide a fourth prompt to the editor LLM that is configured to use the fourth prompt to edit the edited content further according to the second critique of the edited content to generate further edited content, the prompt including the edited content and the second critique of the edited content; and receive the further edited content from the editor LLM.

Aspect 18. A method for content editing, the method comprising: receiving content; providing a prompt to a critic large language model (LLM) that is configured to use the prompt to critique the content according to at least one rule to generate at least one critique of the content, the prompt including the content and identifying the at least one rule that the critic LLM is to critique the content according to; receiving the at least one critique of the content from the critic LLM; providing a second prompt to an editor LLM that is configured to use the second prompt to edit the content according to the at least one critique of the content to generate edited content, the second prompt including the content and the at least one critique of the content; and receiving the edited content from the editor LLM.

Aspect 19. The method of Aspect 18, further comprising: before receiving the content, providing a third prompt to a creator LLM that is configured to generate the content based on the third prompt to receive the content from the creator LLM.

Aspect 20. The method of Aspect 19, wherein the editor LLM is the creator LLM.

Aspect 21. The method of any of Aspects 19 to 20, wherein the at least one rule is identified in the third prompt.

Aspect 22. The method of any of Aspects 19 to 21, wherein the third prompt is identified in the second prompt, and wherein the at least one rule identifies how closely the content fulfills a request in the third prompt.

Aspect 23. The method of any of Aspects 19 to 22, further comprising: retrieve additional information through retrieval-augmented generation (RAG); and modify the third prompt based on the additional information.

Aspect 24. The method of any of Aspects 18 to 23, wherein the editor LLM is the critic LLM.

Aspect 25. The method of any of Aspects 18 to 24, wherein the at least one critique of the content includes at least one score generated from within a range of possible values by the critic LLM according to the at least one rule.

Aspect 26. The method of any of Aspects 18 to 25, wherein the at least one rule identifies at least one of a maximum length for the content, a minimum length for the content, a grammatical rule, or a formatting rule.

Aspect 27. The method of any of Aspects 18 to 26, wherein the content includes instructions to be used as at least a part of a program, wherein the at least one rule is configured to identify, within the instructions, at least one erroneous instruction configured to cause at least one error upon execution of the instructions.

Aspect 28. The method of any of Aspects 18 to 27, wherein the content includes instructions to be used as at least a part of a program, wherein the at least one rule is configured to require that the instructions successfully compile using a compiler.

Aspect 29. The method of any of Aspects 18 to 28, wherein the content includes instructions to be used as at least a part of a program, wherein the at least one rule is configured to require that the instructions successfully execute using at least one of an interpreter or a compiler.

Aspect 30. The method of any of Aspects 18 to 29, wherein the at least one rule identifies a rubric according to which the content is to be scored in the at least one critique of the content.

Aspect 31. The method of any of Aspects 18 to 30, further comprising: generating the prompt based on the content and based on stored information indicative of the at least one rule.

Aspect 32. The method of any of Aspects 18 to 31, further comprising: retrieving additional information through retrieval-augmented generation (RAG); and modifying at least one of the prompt or the second prompt based on the additional information.

Aspect 33. The method of any of Aspects 18 to 32, further comprising: providing a third prompt to the critic large language model (LLM) that is configured to use the third prompt to critique the edited content further according to the at least one rule to generate a second critique of the edited content, the prompt including the edited content and identifying the at least one rule that the critic LLM is to critique the content according to; receiving the second critique of the edited content from the critic LLM; providing a fourth prompt to the editor LLM that is configured to use the fourth prompt to edit the edited content further according to the second critique of the edited content to generate further edited content, the second prompt including the edited content and the second critique of the edited content; and receiving the further edited content from the editor LLM.

Aspect 34. The method of any of Aspects 18 to 33, further comprising: providing a third prompt to the critic large language model (LLM) that is configured to use the third prompt to critique the edited content further according to at least a second rule to generate a second critique of the edited content, the prompt including the edited content and identifying at least the second rule that the critic LLM is to critique the content according to; receiving the second critique of the edited content from the critic LLM; providing a fourth prompt to the editor LLM that is configured to use the fourth prompt to edit the edited content further according to the second critique of the edited content to generate further edited content, the prompt including the edited content and the second critique of the edited content; and receiving the further edited content from the editor LLM.

Aspect 35. A non-transitory computer-readable medium having stored thereon instructions that, when executed by one or more processors, cause the one or more processors to perform operations according to any of Aspects 1 to 34.

Aspect 36: An apparatus for content editing, the apparatus comprising means for performing operations according to any of Aspects 1 to 34.

What is claimed is:

1. An apparatus for content editing, the apparatus comprising:
at least one memory; and
at least one processor coupled to the at least one memory and configured to:
receive content;
provide a prompt to a critic large language model (LLM) that is configured to use the prompt to critique the content according to at least one rule to generate at least one critique of the content, the prompt including the content and identifying the at least one rule that the critic LLM is to critique the content according to;
receive the at least one critique of the content from the critic LLM;
provide a second prompt to an editor LLM that is configured to use the second prompt to edit the content according to the at least one critique of the content to generate edited content, the second prompt including the content and the at least one critique of the content; and
receive the edited content from the editor LLM.

2. The apparatus of claim 1, the at least one processor configured to:
provide, before receiving the content, a third prompt to a creator LLM that is configured to generate the content based on the third prompt to receive the content from the creator LLM.

3. The apparatus of claim 2, wherein the editor LLM is the creator LLM.

4. The apparatus of claim 2, wherein the at least one rule is identified in the third prompt.

5. The apparatus of claim 2, wherein the third prompt is identified in the second prompt, and wherein the at least one rule identifies how closely the content fulfills a request in the third prompt.

6. The apparatus of claim 2, the at least one processor configured to:
retrieve additional information through retrieval-augmented generation (RAG); and
modify the third prompt based on the additional information.

7. The apparatus of claim 1, wherein the editor LLM is the critic LLM.

8. The apparatus of claim 1, wherein the at least one critique of the content includes at least one score generated from within a range of possible values by the critic LLM according to the at least one rule.

9. The apparatus of claim 1, wherein the at least one rule identifies at least one of a maximum length for the content, a minimum length for the content, a grammatical rule, or a formatting rule.

10. The apparatus of claim 1, wherein the content includes instructions to be used as at least a part of a program, wherein the at least one rule is configured to identify, within the instructions, at least one erroneous instruction configured to cause at least one error upon execution of the instructions.

11. The apparatus of claim 1, wherein the content includes instructions to be used as at least a part of a program, wherein the at least one rule is configured to require that the instructions successfully compile using a compiler.

12. The apparatus of claim 1, wherein the content includes instructions to be used as at least a part of a program, wherein the at least one rule is configured to require that the instructions successfully execute using at least one of an interpreter or a compiler.

13. The apparatus of claim 1, wherein the at least one rule identifies a rubric according to which the content is to be scored in the at least one critique of the content.

14. The apparatus of claim 1, the at least one processor configured to:
generate the prompt based on the content and based on stored information indicative of the at least one rule.

15. The apparatus of claim 1, the at least one processor configured to:
retrieve additional information through retrieval-augmented generation (RAG); and
modify at least one of the prompt or the second prompt based on the additional information.

16. The apparatus of claim 1, the at least one processor configured to:
provide a third prompt to the critic large language model (LLM) that is configured to use the third prompt to critique the edited content further according to the at least one rule to generate a second critique of the edited content, the prompt including the edited content and identifying the at least one rule that the critic LLM is to critique the content according to;
receive the second critique of the edited content from the critic LLM;
provide a fourth prompt to the editor LLM that is configured to use the fourth prompt to edit the edited content further according to the second critique of the edited content to generate further edited content, the second prompt including the edited content and the second critique of the edited content; and
receive the further edited content from the editor LLM.

17. The apparatus of claim 1, the at least one processor configured to:
provide a third prompt to the critic large language model (LLM) that is configured to use the third prompt to critique the edited content further according to at least a second rule to generate a second critique of the edited content, the prompt including the edited content and identifying at least the second rule that the critic LLM is to critique the content according to;
receive the second critique of the edited content from the critic LLM;
provide a fourth prompt to the editor LLM that is configured to use the fourth prompt to edit the edited content further according to the second critique of the edited content to generate further edited content, the prompt including the edited content and the second critique of the edited content; and
receive the further edited content from the editor LLM.

18. A method for content editing, the method comprising:
receiving content;
providing a prompt to a critic large language model (LLM) that is configured to use the prompt to critique the content according to at least one rule to generate at least one critique of the content, the prompt including the content and identifying the at least one rule that the critic LLM is to critique the content according to;
receiving the at least one critique of the content from the critic LLM;
providing a second prompt to an editor LLM that is configured to use the second prompt to edit the content according to the at least one critique of the content to generate edited content, the second prompt including the content and the at least one critique of the content; and
receiving the edited content from the editor LLM.

19. The method of claim 18, further comprising:
before receiving the content, providing a third prompt to a creator LLM that is configured to generate the content based on the third prompt to receive the content from the creator LLM.

20. The method of claim 18, wherein the at least one critique of the content includes at least one score generated from within a range of possible values by the critic LLM according to the at least one rule.
